(19) United States
(12) Patent Application Publication
(10) Pub. No.: US 2012/0011040 A1
(43) Pub. Date: Jan. 12, 2012

(54) PRE-BANKRUPTCY PATTERN AND TRANSACTION DETECTION AND RECOVERY APPARATUS AND METHOD

(76) Inventors: Michael L. Beydler, Mission Viejo, CA (US); David K. Beydler, Alhambra, CA (US)

(21) Appl. No.: 13/177,097

(22) Filed: Jul. 6, 2011

Related U.S. Application Data
(60) Provisional application No. 61/361,594, filed on Jul. 6, 2010.
(60) Provisional application No. 61/361,599, filed on Jul. 6, 2010.

(51) Int. Cl. G06Q 40/00

(52) U.S. Cl. 705/35

(57) ABSTRACT

A method for pre-detecting bankruptcy of a consumer with an outstanding credit card balance. The method disclosed compares a first set of consumer transaction data to a second set of consumer transaction data in accordance with a debt grading criteria to generate a first and second set of association data. Association rule algorithm executes and parses the first and second set of association data into one or more product or service associations. A transaction pattern is generated of the consumer based in part on relatedness of the one or more product or service associations in conjunction with pre-bankruptcy associative elements. Private documents from lien holders and public documents from pending and completed court cases are analyzed to generate case success indicators. Pre-bankruptcy associative elements are updated based on the generated bankruptcy case success indicators. A debt score is generated that indicates a level of collectability of the outstanding credit card balance.

### PRIORITY AND RELATED APPLICATION(S)

This non-provisional US utility patent application is a co-pending application to U.S. non-provisional application Ser. No. ______ “POST BANKRUPTCY PATTERN AND TRANSACTION DETECTION AND RECOVERY APPARATUS AND METHOD”, which application is incorporated by reference in its entirety, and this non-provisional US utility patent application further incorporates by reference in its entirety and claims priority to U.S. provisional patent application entitled “PRE-BANKRUPTCY FRAUD DETECTION APPARATUS AND METHOD” Ser. No. 61/361,594 filed on Jul. 6, 2010, AND “POST-BANKRUPTCY FRAUD DETECTION APPARATUS AND METHOD” Ser. No. 61/361,599 filed on Jul. 6, 2010, both with the same inventors as herein application.

### BACKGROUND OF THE INVENTION

1. Field of the Invention

The invention relates generally to the field of financial data processing systems, and specifically in one exemplary aspect to lender scoring systems employing pre-bankruptcy detection for consumer credit card transactions and modeling thereof.

2. Description of Related Technology

Financial data processes, both apparatuses and methodologies, are well known in the art. Financial data processing, such as related to lender profiling, lender behavior analysis and modeling, for instance as it relates to rating lenders based on data derived from their respective consumers are disclosed in representative US Patent Publication 2009/0248573, which is herein incorporated by reference in its entirety. Another methodology is disclosed in representative US patent publication 2009/02344683, which is herein incorporated by reference in its entirety, determines a risk of transaction by conversion of high categorical information, such as text data, to low categorical information, such as a category or cluster IDs.

Still other representative financial data processes, such as disclosed in US Patent Publication(s) US 2009/0222380, US 2009/0048966, US 2008/0255951, US 2008/0222027, US 2007/0288360, US 2007/0011083, US 2006/0226216, and US 2006/0212366, which are all herein incorporated by reference in their entireties, utilize one or more techniques. These methods include providing a seller an irrevocable method of receiving funds, generating excess funds using a credit instrument, and utilizing various data sources to provide outputs to describe consumers spending behavior. The methods further include matching an applicant with a position grade based on credit information, processing of asset financing transactions, and providing risk data, e.g., based on a denial rule set, to an entity engaged in a transaction with a consumer.

Yet other representative financial transaction processes, such as those disclosed in U.S. Pat. No. 7,567,934, U.S. Pat. No. 7,546,271, U.S. Pat. No. 7,403,922, U.S. Pat. No. 7,376,618, and U.S. Pat. No. 7,272,575 (which are herein incorporated by reference in their entireties) are specific hardware/software implementation(s) that utilize one or more techniques to prevent or reduce potential fraudulent usage thereof. Some of these techniques include limit use of card number, provide remote access devices for accessing a limited use credit card number, and detect inconsistencies in one or more data fields from a plurality of database records. Still other techniques include match of records using highly predictive artificial intelligence patterns, data mine to convert high categorical information to low categorical information to generate a level of risk of a particular transaction, and develop Complete Context™ Bots for an organization.

Yet other financial transaction processes, such as those disclosed in U.S. Pat. No. 7,263,506, U.S. Pat. No. 7,039,654, U.S. Pat. No. 6,999,943, U.S. Pat. No. 6,785,592, U.S. Pat. No. 6,658,393, and U.S. Pat. No. 5,732,400 (which are herein incorporated by reference in their entireties) disclose specific hardware/software implementation(s) to prevent or reduce potential fraudulent usage. These hardware/software usage include offering multiple payment methods to improve user profitability by directing profitable transactions to participating issuers, generate a predictive model based on historical data, and request current transaction authorization through one or more sources.

However, there is still a need for improved financial processing processes and apparatuses that permit easy initial configuring and reconfiguring, i.e., multiple adaptive learning and neural network modeling algorithms, to improve real-time detection of recoverable and/or fraudulent transactions, which minimizes the required labor and/or time from initial financial screening to detection of recoverable and/or fraudulent transactions. Such improved apparatus and methods would ideally minimize labor-intensive tasks of adjustment and/or installation of algorithms and structures.

Furthermore, it would be advantageous for an improved process or system to provide multiple configurations, and thus permit the creation of user-customized consumer credit collection recovery configurations using one or more structures or components and software routines. In addition, the improved process or system should assist creditors in recovery of delinquent consumer credit lending and thereby potentially reduce a number or magnitude thereof of consumer financial credit write-offs by a lender, such as a financial institute, banking association, or credit card issuer.

### SUMMARY OF THE INVENTION

In one aspect of the present invention, a credit card debt recovery system (system) is disclosed. More specifically, a consumer credit card debt collection recovery system recovers money from credit card charging following issuance of credit to account holder(s). In one embodiment, the credit card debt collection recovery system includes a multitude of adaptive learning and neural network modeling algorithms to detect recoverable credit card charges based on a detection of data transactions in pre-bankruptcy associative elemental categories.

In one aspect, a method for pre-detecting bankruptcy of a consumer with an outstanding credit card balance is disclosed. In this method, a first set of consumer transaction data is compared to a second set of consumer transaction data in accordance with a debt grading criteria to generate a first and second set of association data. Association rule algorithm executes to parse the first and second set of association data into one or more product or service associations. A transaction pattern of the consumer is generated based in part on relatedness of the one or more product or service associations in conjunction with pre-bankruptcy associative elements. Private documents are analyzed from lien holders and public documents from pending and completed court cases of others similar situated to generate case success indicators. Pre-bankruptcy associative elements are updated based on the generated bankruptcy case success indicators. A debt scorecard is generated that indicates a level of collectability of the outstanding credit card balance.

In one variant, a starting point is determined for selection of the first and second set of association data to generate in accordance with one or more detections a pattern of uncharacteristic credit card charges. In another step, the debt grading criteria includes adjusting a confidence level and a financial baseline for the debt scorecard based on real-time information obtained from recent transactions indicators including at least one of frequency of payment, level of payment, types of charges, and frequency of charges.

In another variant, the first set of consumer transaction data is older in time than the second set of consumer transaction data.

In yet another variant, the step of analyzing public documents from pending and completed court cases includes analyzing transactions of other debtors from pending and completed court cases and adjusting the association rule algorithm and the pre-bankruptcy associative elements; and rerunning the association rule algorithm against outstanding credit card transactions.

In yet another variant, the step of wherein executing association rule algorithm that parses the first and second set of association data into one or more product or service associations includes executing the pre-bankruptcy associative elements against one or more complete or partially complete item sets or item combinations that are at least partially identified by the one or more product or service associations.

In yet another variation, the step of wherein one or more complete or partially complete item sets includes one or more complete or partially complete merchant or service product or service identification codes or text that when associated with each other assists identification of one or more uncharacteristic purchases including consumer spending pattern.

In yet another variation, the consumer spending pattern comprises analysis of pre-bankruptcy elemental categories of the following factors: uncharacteristic purchase, location of charging, type of charging, time of charging, frequency and number of different charges.

In another aspect, a method is disclosed for detecting credit card payment default. The method includes the steps of:

comparing a first set of consumer transaction data to a second set of consumer transaction data in accordance with a debt grading criteria to generate association data;

selecting a starting point for selection of the first and second set of consumer transaction data to generate the association data in accordance with one or more detections of a pattern of uncharacteristic credit card charges; wherein the starting points provide a movable window to determine a listing of uncharacteristic purchases as compared to characteristic purchases;

executing association rule algorithm configured to utilize pre-bankruptcy associative elements against one or more complete or partially complete item sets or item combinations that are at least partially identified by one or more product associations and to parse the association data into the one or more product or service associations; and

generating a transaction pattern of the consumer based in part on relatedness of the one or more product or service associations in conjunction with pre-bankruptcy associative elements; executing the pre-bankruptcy associative elements against one or more complete or partially complete item sets or item combinations that are at least partially identified by the one or more product or service associations.

In one variant, the method may include the step of analyzing private documents from lien holders and public documents from pending and completed court cases to generate case success indicators.

In one variant, the method may include the additional step of updating the pre-bankruptcy associative elements based on one or more generated case success indicators.

In one variant of this step, the method may include the step of generating a debt scorecard that indicates a level of collectability of an outstanding credit card balance.

In one variant, the first set of consumer transaction data is older in time (start at a period earlier and/or end at a period later or earlier) than the second set of consumer transaction data.

In one variant, the debt grading criteria includes adjusting a confidence level and a financial baseline for the debt scorecard based on real-time information obtained from recent transactions indicators including at least one of uncharacteristic purchase, frequency of payment, level of payment, types of charges, and frequency of charges.

In one variant, the step of analyzing public documents from pending and completed court cases includes analyzing transactions of other debtors from pending and completed court cases and adjusting an association rule algorithm and pre-bankruptcy associative elements; and re-running association rule algorithm against any outstanding credit card transactions.

In one variant, one or more complete or partially complete item sets includes one or more complete or partially complete product or service identification codes or text that when associated with each other assists identification of one or more uncharacteristic purchases including a consumer spending pattern.

In one variant, the consumer spending pattern includes analysis of the pre-bankruptcy associative elements including analysis of the following factors: uncharacteristic purchase, location of charging, type of charging, time of charging, frequency and number of different charges.

In another aspect, a method is disclosed to assist in generation of objective evidence to recover consumer credit card transactions. In the method, a first set of consumer transaction data is compared to a second set of consumer transaction data in accordance with a debt grading criteria to generate a first and second set of association data within a movable window. In one variant, the moveable window may be determined by a selected starting point for selection of the first and second set of consumer transaction data in accordance with one or more detection pattern of uncharacteristic credit card charging. In one variant, the method may include the step of executing association rule algorithm that parses the first and second set of association data into one or more product or service associations. In the same variant, this method may include the step of generating a transaction pattern of the consumer based in part on relatedness of the one or more product or service associations in conjunction with pre-bankruptcy associative elements. In another variant, the method may further include the step of analyzing private documents from lien holders and public documents from pending and completed court cases to generate bankruptcy case success indicators. In yet another variant, the method may further include the step of updating the pre-bankruptcy associative elements based on one or more generated bankruptcy case success indicators. In yet another variant, the method may further include the step of generating a debt scorecard that indicates a level of collectability of an outstanding credit card balance.

These and other embodiments, aspects, advantages, and features of the present invention will be set forth in part in the description which follows, and in part will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

FIG. 1 is a block diagram of system for analyzing and processing in accordance with a pre-bankruptcy detection algorithm including pattern recognition and association rule learning.

FIG. 2 is a diagram that illustrates pre-bankruptcy association learning rule algorithm of FIG. 1.

FIG. 3 is a diagram of lattice matrix used in scoring and grading credit ratings of consumers in accordance with weighting and pre-bankruptcy association rules in accordance with FIG. 1.

FIG. 4 is a diagram that illustrates the pre-bankruptcy association rule algorithm and association learning rule algorithm process flow of FIGS. 1-3.

FIG. 5 is a graph that illustrates spending spikes and baseline credit card and financial transaction scoring of several clients utilizing the principles of FIGS. 1-4.

FIG. 6 is a diagram of a system and apparatus utilizing the pre-bankruptcy detection algorithm of FIG. 1.

FIG. 7 is a flow chart illustrating the pre-bankruptcy detection algorithm of FIG. 1.

### DETAILED DESCRIPTION

Reference is now made to the drawings wherein like numerals refer to like parts throughout.

### Overview

In one salient aspect, the present invention discloses apparatuses and methods for detecting recoverable and/or fraudulent consumer transactions related to, inter alia, lender sources including credit card institutional lenders. In particular, the present invention discloses an apparatus and method configurable to assist a lender or financial institution in evaluating a method for initiating collection proceedings against consumer credit card debtors. Furthermore, the present invention further discloses a technique for accurately portraying in real-time, with incidents of recoverable credit card transactions identified, such as recently purchased luxury items. These recoverable credit card transactions are collected as well as empirical data associated with groups of credit card debtors in a convenient database that may be reviewed in a convenient manner.

In addition, the apparatus advantageously provides a more intuitive method to view credit scoring of consumer transactions in real-time situations where human review and operations management cannot detect recoverable transactions or fraud until months after the transaction was completed. For instance, with this invention, not only can a user with a real-time generated report discover there is a recoverable (e.g., non-extinguishable) fraudulent transaction but distinguish physical and empirical characteristics of the transactions, e.g., location of the transaction, type of merchant, frequency of the transaction, amount of spending at a particular establishment and relate this to current consumer debt. As such, the apparatus allows a user's brain to improve intuitive distinguishing signals of future financial delinquency details, even before one or more credit card invoices are delinquent or overdue.

In addition, the apparatus advantageously provides the ability to preserve database information from different sources and attaches and adjusts indicators and details of transactions into a more natural format, and into a single credit card recovery report.

Advantageously, in one embodiment, database algorithm(s) improves the detection of consumer recoverable transactions when purchasing from merchants that are of a different type or kind thereof from that of the historical transactions (for example purported purchase of expensive luxury car, e.g., Porsche sports car, exotic cruise ship passage, rare and expensive perfumes, silk, antiques, collectables, etc.). Advantageously, in one embodiment, the system improves a user's ability to distinguish details of transactions and other finer features that could not otherwise be seen using conventional financial programming software or apparatus, such as credit checks. Furthermore, one or more data mining routines of one embodiment unobtrusively highlights objective evidence of potentially recoverable or fraudulent transaction information for collection agencies to utilize in evaluating likelihood or probability of successful credit card collection debt efforts. In addition, the principles of these embodiments can be part of a bankruptcy assist program or service tool that will aid in the detection of recoverable consumer transactions.

### Exemplary Apparatus, System, and Method

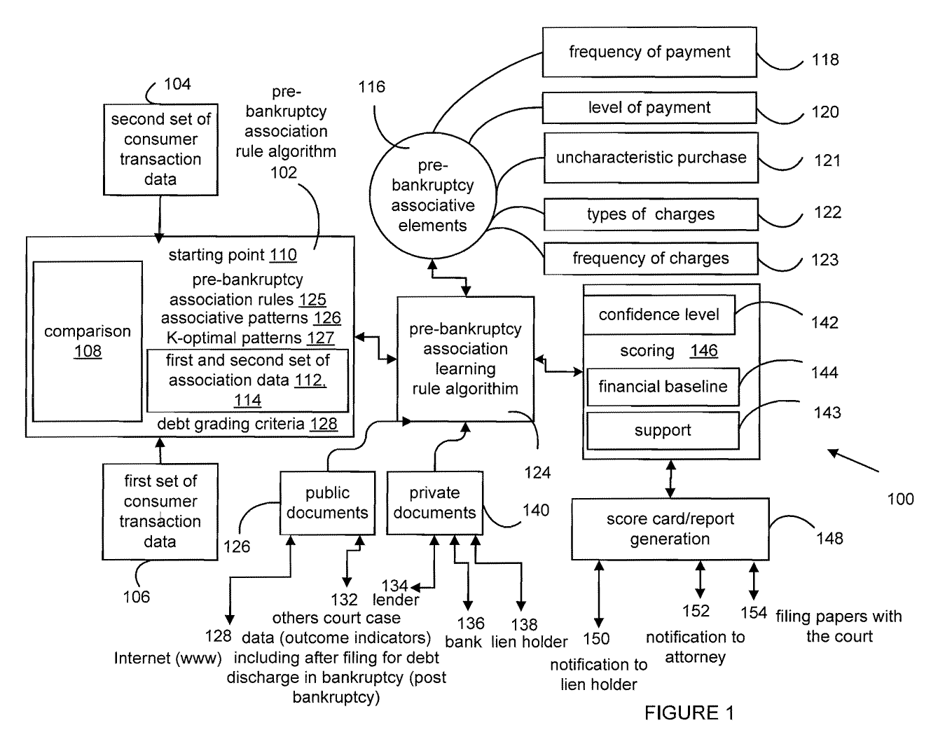

Referring to FIGS. 1-7, exemplary embodiments of the apparatus, system, and methods of the invention are described in detail. It will be appreciated that while described primarily in the context of a consumer credit card recovery system and apparatus, there are other uses. For example, system and apparatus detects recoverable credit card transactions and recovers uncollected credit card billings based on consumer history, transactional type, frequency of transactions, timing of transactions, there are at least portions of the apparatus and other methodology for configuring the apparatus, system, and methodology described herein that may be used for other applications or purposes.

For example, it will be recognized that the present invention may be used to create a stand-alone credit card recovery system, transaction recovery assist system, or provide assistance in the creation of consumer credit payment models and credit coding charts that indicate objective evidence of credit history and rationale to predict probability of timely future payments. Other functionality or applications of the present invention may include providing objective evidence, rationale, and/or assistance in clearance processing of retail and commercial credit card application(s), determination of type and line of credit to provide a prospective consumer, security monitoring of present consumer credit card transactions, car dealership loan application processing and clearance processing, and the like. As such, a myriad other functions will be recognized by those of ordinary skill given the present disclosure.

Referring to FIG. 1, system 100 for analyzing and processing in accordance with a pre-bankruptcy detection algorithm (PBFD) is disclosed. The system 100 includes pattern recognition algorithm 102 (i.e., pre-bankruptcy association rule algorithm) and association rule learning algorithm 124. In one embodiment, association rule learning algorithm 124 utilizes public documents 126, private documents 140, analyzed by quantitative and qualitative association rules 125 (e.g., categorical and data). In one variant, k-optimal patterns 127 may be utilized in conjunction with pre-bankruptcy associate rule learning algorithm for recovery coding and grading of consumer financial transactions. In one embodiment, comparison 108 is performed between first set of consumer transaction data 106 (e.g., older financial transaction data, X) and second set of consumer transaction data 104 (e.g., newer financial transaction data, Y) in accordance with a debt grading criteria. Supplemental financial transaction data for X and Y (for first set of consumer transaction data 106 and second set of consumer transaction data 104 respectively) is stored at several times (D), e.g., t1, t2 . . . tm.

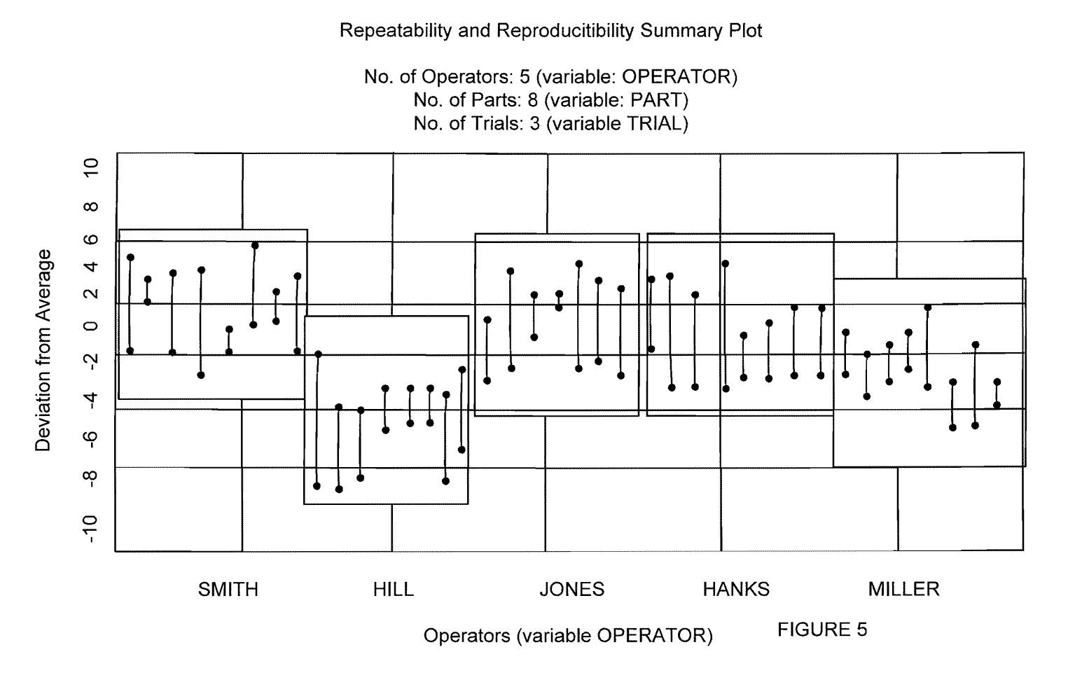

As illustrated in FIG. 5, time stored transaction data illustrates at a first time (e.g., t1) credit card debtor initiates a spike in credit payments along with a cluster of purchases on clothing and jewelry and at second time (t2) the credit card debtor files. In one example, pattern recognition algorithm 102 compiles and stores a first set of association data 112 for first set of consumer transaction data 106 and second set of association data 114 for second set of consumer transaction data 104.

### Starting Point Selection

Referring to FIG. 1, during comparison 108, first and second set of association data 112, 114 purchases and payment information are cross-referenced against pre-bankruptcy associative elements 116. In one embodiment, starting point 110 for selecting transactional history is unique for first and second set of consumer transaction data 106, 104. In yet another variant, starting point 110 and a time window is chosen, for instance, with staggered, partially overlapping transactional history for first and second set of consumer transaction data 106, 104 and/or first and second set of association data 112, 114. In one embodiment, starting point 110 for selecting transaction history for populating first or second set of consumer transaction data 106, 104 may begin with an uncharacteristic purchase or transaction. In one variant, an uncharacteristic purchase or transaction may include consumer cash advances (as discussed supra) and/or consumer purchasing a new yacht, luxury automobile, classic automobile, or the like when never done so before, and later not paying outstanding credit card balance. In yet another embodiment starting point 110 may include a large number of or uncharacteristic purchase 121 or transactions of smaller purchases including frequency of charges 123. For instance, uncharacteristic purchase 121 or transactions of smaller purchases including frequency of charges 123 from the following transactions: restaurant bill no. 1 $25.00, restaurant bill no. 2 $50.00, high-end retail or department store purchase $25.00, car repair $300.00, rent payment $600.00, big screen television purchase $650.00, computer repair $60.00, hair cut $30.00, pet food $70.00 each transacted or purchased within minutes or hours of each other on a single day or on consecutive days. In this case, a large credit card balance (e.g., one that exceeds a specified level, for instance, $1200.00) is racked-up or generated within hours or days of the first of these large numbers of smaller purchases, which pattern indicates a likely possibility of default and good opportunity to identify objective evidence to assist a credit card company for collection purposes.

In one alternative, starting point 110 may be set in accordance with when an uncharacteristic purchase 121 causes an increase in a consumer's daily outstanding credit card balance. In one example, a consumer payment history is good at time t1; however, at time t2 (one month later) the consumer makes uncharacteristic purchase 121, e.g., a yacht or new car, and never makes payments on this purchase. In one variant of this embodiment, starting point 110 may be set after the consumer's last credit card payment date to illustrate poor credit history; thus, starting point 110 may be chosen to increase objective evidence of potential default. In other words, starting point 110 may be chosen to increase opportunity of a lien or collection agency to collect on a credit card balance (improve collection grade or scorecard on this consumer).

In another alternative, consumer transactions at starting point 110 (e.g., start date for transaction review) includes large number of non-dischargeable bankruptcy transactions of items (products) or services. For example, non-dischargeable transactions, even if they add to a high amount, may not be collectible. However, purchases of luxury item such as a yacht may signal starting point 110 for first set of consumer transaction data 106 being reselected just before purchase of luxury item to maximize collection of debt.

Advantageous as compared to many conventional collection agencies where a collection period is fixed, system 100 has starting point 110 that is variable for the collection process. Thus, starting point 110 being variable (variable starting point) for first set of association data 112 or second set of association data 114 provides to a credit card company or lien holder a variable, that on an individual basis, is selectable and adjustable. For example, the variable starting point may be chosen to achieve a maximize recoverable amount of non-dischargeable items, where the selection process uses identified physical characteristics in a pre-bankruptcy setting of uncharacteristic transactions for collection of outstanding credit card balance.

Furthermore, as compared with many conventional collection agencies where highest value accounts are pursued through the collection process, system 100 provides automated capability of quickly identifying recoverable (non-dischargeable) items on a sliding time period scale (variable starting point 110 for first or second set of association data 112, 114) with regard to multiple outstanding credit card accounts. Consequently, system 100 in an automated fashion quickly compares numerous consumer outstanding credit card balances with objective account criteria (pre-bankruptcy associative elements, which will be discussed supra).

Thus, system 100 capabilities provide for identification of high opportunity collection of outstanding credit card accounts before a credit card holder receives a bankruptcy decree and/or continues preparing a bankruptcy filing (e.g., pre-bankruptcy), which filing, if successful may prevent credit card collection all together. Furthermore, use of debt grading criteria when comparison of first set of association data 106 and second set of association data to more readily keep track of in real-time consumers having a lower risk of default. As such, debt grading criteria decreases collection scorecard for debts or non-payments beyond a specified period so that pre-bankruptcy association rule algorithm 102 generates a more real-time and update scorecard profile as determined on a case by case basis in conjunction with starting point 110 as compared to many conventional credit card rating processes.

### Pre-Bankruptcy Associative Elements

Referring again to FIG. 1, system 100 includes pre-bankruptcy associative elements 116 for credit card transactions which may include any or all the following: frequency of payments 118, level of payment(s) 120, uncharacteristic purchase 121 of product or service, types of charges 122, frequency of charges 123, and others court case outcomes 132. For example, if consumer frequency of payment 118 increases as well as level of payment 120 increases, then pre-bankruptcy associative elements 116 analysis would result in a lower risk of credit card default (e.g., lower inability to pay score, fraud score) as compared to a consumer with infrequent or minimum payments on one or more designated payment periods. In yet another example, uncharacteristic purchase 121 such as type of charges 122 and/or frequency of charges 123 such as multiple jewelry necklace purchases with no prior purchases like these would result in an increased default score (higher in ability to pay score) in conjunction with information on low frequency of payments 118.

Continuing with this embodiment, as illustrated above, starting point 110 for collection or choice of outstanding credit card accounts may be altered or changed in response to information obtained when comparison of various starting period purchases. In response of the first and second sets of consumer transaction data 106, 104, association data 112, 114 along with debtor court case data are indexed and referenced as system 100 searches for match (e.g., best match for data comparisons). Furthermore unfinished or pending court indicators (e.g., preliminary court rulings, record of the court's minutes) may help as well. In addition, others court case data 132 holds relevancies that create associations to assist in generation of a consumer credit prediction model for this consumer or others.

For example, pre-bankruptcy associative elements 116 used in conjunction with post bankruptcy data including others court case data 132 are utilized to form system 100. For instance, system 100 stores groups of pre-bankruptcy associative elements 116 (e.g., for a specified period, a debtor increases purchasing of TVs, couches, etc. while decreasing credit card payments). These purchases create associations within system 100 and are utilized to generate credit worthiness predictions based on matching with others court case data 132 that have generated chapter 7 bankruptcies or are pending before the chapter 7 bankruptcies court.

### Consumer Spending Patterns

Referring to FIG. 1, supplemental financial data for X and Y are compared for current period (tm) looking backwards until uncharacteristic financial transaction item (i.e., uncharacteristic purchase 121 of product or service) has been located (e.g., a $5,000 cash advance, balance transfer, or the like type of payment behavior). Using this uncharacteristic financial transaction item (i.e., uncharacteristic purchase 121 of product or service) system 100 determines starting point 110 for pre-bankruptcy detection and/or additional information may be required to determine if one or more recoverable or fraudulent transactions have been located. In one exemplary embodiment, consumer spending pattern consistencies are analyzed by converting linear transaction amounts into waveform over a specified time delta (see FIG. 5). In one variant, consumer-spending patterns include types of purchases along with variables of, for instance, time aging of purchases and purchase repetitiveness that included as part of debt grading criteria. In one example, waveform data is averaged and represented as baseline credit pattern for the array (e.g., 0 in FIG. 5). Purchase ripples (e.g. spikes in FIG. 5) that stand out (e.g., positive spikes are created by repeat spending patterns on one or more item sets) from baseline credit patterns are tagged and matched as closely as possible with pre-bankruptcy association rules 125 to generate a hit factor, e.g, a probability of individual debtor filing (or declaring) bankruptcy in the future.

In one embodiment, pre-bankruptcy association rules 125 determine and satisfy a minimum support level (e.g., financial baseline 144 of a consumer or group of consumers for one or more consumer transactions) and a minimum confidence level (e.g., confidence level 142 that is an index to determine if a consumer transaction is recoverable through a collection process). In one embodiment, scoring of potential bankruptcy (e.g., chapter 7) or potential credit misuse with individual debtors is reviewed in accordance with probability factoring (pre-bankruptcy association learning rule algorithm 124).

Following, system 100 generates a scorecard. In one example, a scorecard indicates a scoring percentage based upon, for instance, formation and derivates of outputs based in part on minimum support level (e.g., support level 143) and confidence level (e.g., confidence level 142). A credit lender may use scoring 146 of scorecard data to adjust consumer credit card spending limits or perhaps terminate credit card entirely. In one variant, minimum support level applies to all, one, or more groups of frequent item sets in a database.

### Pre-Bankruptcy Association Rules

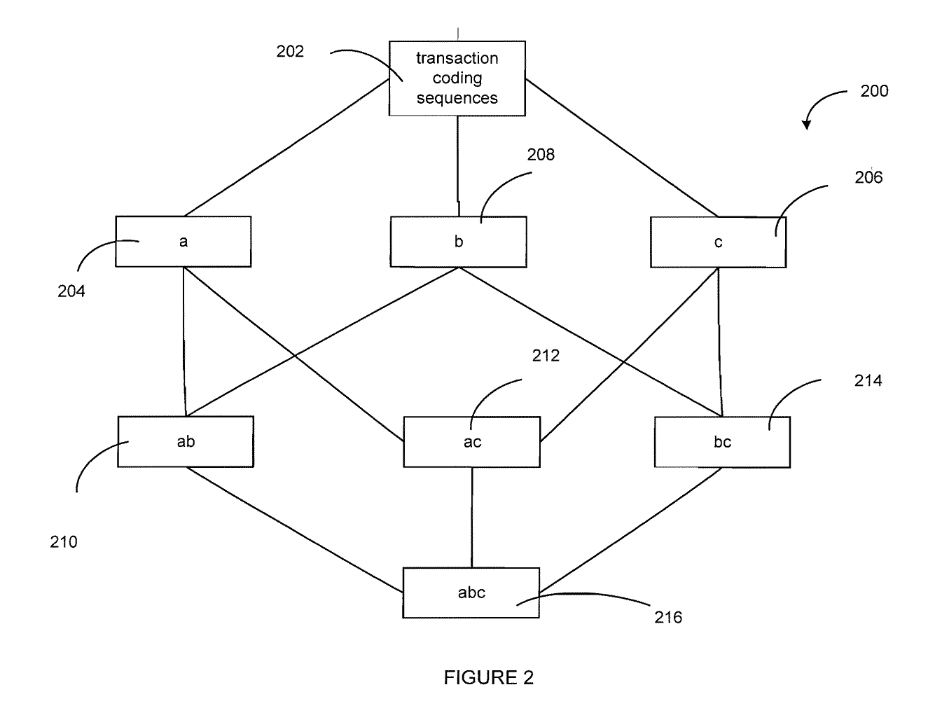

Referring to FIG. 2, frequent item sets and minimum confidence constraints are utilized to create pre-bankruptcy association rules. In one embodiment, frequent item sets are chosen from one or more databases (e.g., financial data source(s), public database(s), commercial database(s) or the like) by searching one or more item sets (e.g., item combinations). Advantageously, system 100 in real-time derives and modifies its association rules (or table thereof) based on complete or partial data contained in item sets.

Continuing with this embodiment, system 100 association rules are derived from or more item sets. In one variant, a first item set may be a head (first part of pre-bankruptcy association rules 125) and second item set may be a body (second part of pre-bankruptcy association rules 125). In one variant, head and body may represent simple codes, text values (items), and/or conjunction of codes and text values. In one exemplary embodiment, first item set 210 includes Car=Porsche and Age<20 (ab in FIG. 2) and second item set 214 includes Risk=High and Insurance=High (ac in FIG. 2). Continuing with this embodiment, system 100 would assign a logical connection between first item set being body and second item set being head to form an association rule 216 (abc in FIG. 2) utilized to evaluate sets of association data 106, 104 as part of comparison 108 process.

Furthermore, pre-bankruptcy association rules 125 identify associations (e.g., regularities) between one or more item sets (e.g., item sets 210, 212, 214) responsive to or based on supplemental information with first and second set of consumer transaction data 106, 104. In one illustrative example, a convenience store may find an association between products and/or services (beer, peanuts, hot dogs, and water tank refilling). Based on data patterns of repeat purchases, one or more product or service associations may indicate customers who buy beer and peanuts may more likely buy hot dogs and refill empty water tanks or propane tanks on a holiday weekend. To maximize store sales (and profitability) and based on a realized data pattern, a convenience store arranges these products or services closer to one another based upon product associations.

In this case, pre-bankruptcy association rules 125 generated in real-time assist in creation of improved accuracy representations of consumer's current financial status (real time snapshot of a consumer's credit viability). In contrast, conventional credit check services use of historical data (credit check information), which information or data may be at best weeks or months old and each of the transactions merely identify by, for instance, business owner code or name, which may not represent a true type or category of the consumer's purchase. Thus, using conventional product or service categories, identified transactions that may be recoverable by credit card collection agencies may be mis-identified, therefore, these identified transactions may not be tagged as recoverable transactions (e.g., non-dischargeable by a bankruptcy court) and not properly represent to a creditor a consumer's real-time pre-bankruptcy financial status. In contrast, system 100 provides continuous, real-time analysis of transactions for non-bankruptcy debtors and associates completed transaction association snapshots with post bankruptcy data trends to find relevancies to create objective indicators (graphical, tabular, and report) to use during collection processing.

Furthermore, pre-bankruptcy association rules 125 are real-time graded. In one example, if a consumer begins paying off a line of credit in a more expeditious manner, then system 100 indicates real-time, improved consumer credit status, e.g., improve scoring 146 (i.e., scorecard status for recovery decreases) and increase their credit line. In contrast to system 100, conventional credit checks may require multiple months to rescore and update (improve or decrease) a consumer's credit score.

### Transaction Scoring

Consumer financial transactions are scored and graded. In one variant, specific performance requirements relevant to Critical-To-Quality (CTQ) characteristics are mapped including identified inputs and outputs.

Below are formulas used in scoring and grading credit ratings of consumers in accordance with weighting and pre-bankruptcy association rules.

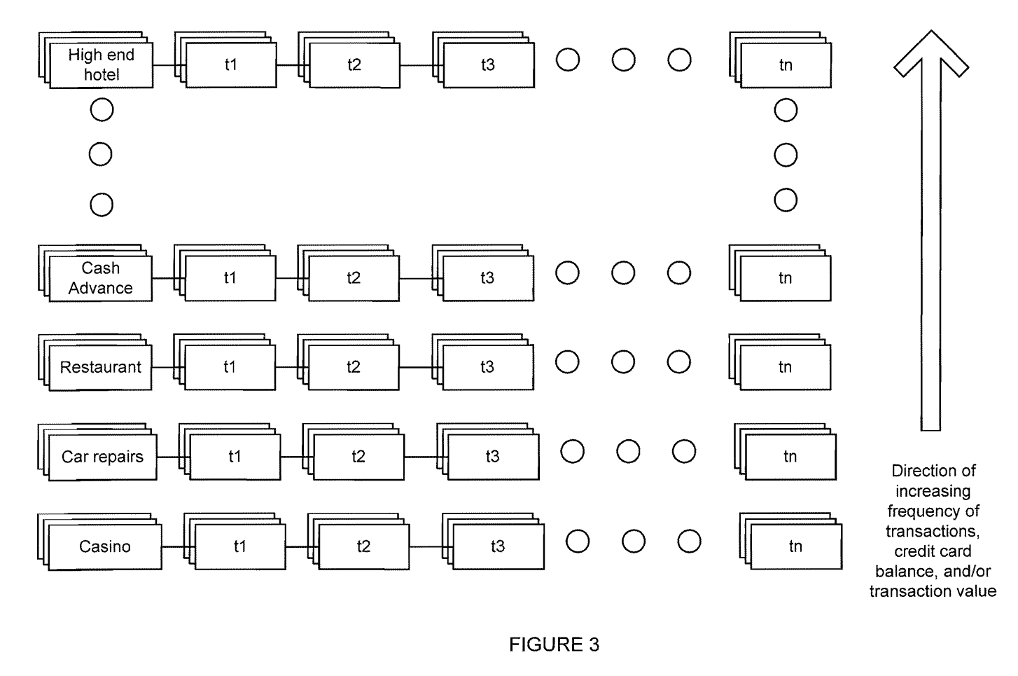

Referring to FIG. 3, frequent item sets are utilized to form a lattice. In the lattice, various letter groups or supplemental information in one or more boxes indicate frequency of groupings of transactions that contain a combination of one or more items. Lower levels of lattice include a minimum number of purchased items to satisfy or more pre-bankruptcy associative elements 116 criteria. Lattice applies pre-bankruptcy association rules 125 required to satisfy specified support and confidence levels. In this embodiment, the lattice is categorized or arranged into item sets, from bottom to top, in a direction of increasing frequency of transactions, credit card balance, and/or transaction value in accordance with pre-bankruptcy associative elements 116 including frequency of payments 118, level of payment 120, uncharacteristic purchase 121, types of charges 122, and frequency of charges 123.

### Pre-bankruptcy Association Rule Generation

Pre-bankruptcy association rule generation occurs in steps of: minimum support level being applied to find frequent item sets in a database, and frequent item sets and the minimum confidence constraint used to form the pre-bankruptcy association rules 125.

Below is an association rule algorithm applied to consumer financial transactions:

conf(X [symbol] Y)=supp(X∪Y)/supp(X)D={t₁,t₂, . . . ,tₘ}

In a generated bankruptcy association rule set, X and Y refer respectively to an array of first and second set of consumer transactions 106, 104. The rule X=>Y holds record set D database with confidence (conf). In this example, D record set has line item transactions t (t₁, t₂ . . . tₘ) at various times (e.g., specified period) form D database. Each transaction in D database has a unique transaction ID and contains a subset of one or more item set(s) of pre-bankruptcy association rules 125.

Within D database, each of the one or more item sets(s) are individually examined for spending patterns in accordance with: frequency of payment 118 (e.g., transaction balance(s) for each line item), level of payment 120 (e.g., transaction payment(s)), uncharacteristic purchase 121, and types of charges 122 and frequency of charges 123 (e.g., transaction purchases, cash-transfer, cash advances). In one embodiment, k-optimal patterns 127 are utilized to evaluate spending patterns and perform deep data mining.

### Non-Unique Transactions

If confidence (conf) 142 of records in D that has support (sup) 143 X also has support (sup) 143 Y, the rule X=>Y has support s 143 in the record set. In this case, s percentage (%) of records in D support (supp) X∪Y (union of X and Y). The support (supp) 143 (X) of an item set contained in X∪Y is defined as the proportion of transactions contained in a data set for a specified period that contain one or more item sets. For example, item set may be assigned a support value of ⅛=0.125 because it occurs in 12.5% of all transactions t (t₁, t₂ . . . tₘ) (1 out of 8 transactions) during a specified period in X.

### Unique Transactions

If one or more t transactions contained in X are unrelated to prior purchases conditions A and B of Y, then pre-bankruptcy association rules 125 learn and create an association with prior purchase conditions A and B by determining relatedness or association with prior purchases:
strength (A & X→B)≈strength (A→B)
lift (A & X→B)≈lift (A→B)

### Aging Transactions

Unique transactions (uncharacteristic purchases) are measured against aging, (changed in relevance) in accordance to any or all the following factors: similarity to prior (pre) and post purchases of a same or similar line transactions, a severity rating based on type (which may be based on SIC code relevance, e.g., merchant coding). In this case, partial data sets are used in word searches to locate or create associations with prior (pre) and post purchases of same or similar line transactions.

Below gradient function creates a scalar representation of transaction A (e.g., part of X) to adjust or move relevance (x) of a transaction A in reference to age (f) of transaction to form debt grading criteria 128. In this case, pre and post transactions are treated on age graded scale so historical purchases of one or more item set(s) are factored in system 100 collection processing.

∇(f(Ax))=(A)^{T}(∇f)(Ax))=(A)⁻¹(∇f)(Ax))

### Capture Recovery Amount

The above equations assist in identifying and capture a recoverable case amount for settlement purposes that has objective evidence for collection.

$$f ( x ) \approx f ( {x}_{0} ) + {( ∇ f )}_{{x}_{0}} \cdot ( x - {x}_{0} )$$

$$∇ f = ( \frac{\partial f}{\partial {x}_{1}} , … , \frac{\partial f}{\partial {x}_{n}} ) .$$

### Gradient Theorem

Using the above equations: a vector associate representation is created for scalar values included as part of a transaction (f(x)) characterized by pre-bankruptcy associative elements 116 of one or more item set(s) to identify a direction of increase or decrease in spending or payback of credit, where:

f(xo) represents an average purchase transaction amount for a line item

f(x) represents a real-time purchase transaction amount for a line item

x1 . . . xn represents multiple transactions per item set

∇T represents a scalar representation of a rate of change Δ (delta) of real-time purchase transaction amount per line for x₁ to xₙ transactions

f(xo) represents an average transaction amount per item set

$$\frac{\partial ( {f}_{1} , {f}_{2} … {f}_{n} )}{\partial ( {x}_{1} , {x}_{2} … {x}_{n} )}$$

### Jacobian Matrix

Using the above equation, each line-transaction of system 100 is represented in a n×n matrix of first-order partial derivatives of the functions f₁, f₂, f₃ relative to x₁, x₂, x₃ to establish a direction of a rate of change (decrease or increase) in a spending or payback pattern for a consumer for multiple line item transactions.

$${\sum }_{j = 1}^{n} {X}^{j} ( ϕ ( x ) ) \frac{\partial }{\partial {x}_{j}} ( f \cdot {ϕ}^{- 1} ) {\vert}_{ϕ ( x )} ,$$

### Riemannian Manifolds

Using the above equation, a real differentiable manifold is created for matrix X of line item transactions x in which each tangent space is equipped with an inner product, e.g., Riemannian metric, to provide smoothing functionality between points of each of unique line item transactions x and item sets associated with pre-bankruptcy association rules 125.

### Example of System 100 Operation

In operation, system 100 compares line items transactions from a first period with those of another period in accordance with pre-bankruptcy associative elements 116 to create pre-bankruptcy association rules 125. Frequent line item transactions and unusual line item transactions are marked for further characterization and association with pre-bankruptcy associative elements by system 100. In accordance with computations discussed above, e.g., unique transactions, non-unique transactions, and aging, are utilized to create disputed amount being derived from a summation of transactions t within a specified period (t₁ . . . tₙ). For example, a delta summation of f(x−x₀) is created including line item transactions, purchases, cash advances, balance transfers minus payments within a specified period (e.g., a given time and/or date range). Initially, transactions t at times (t₁ . . . tₙ) are chosen from a fixed start date to any negative (prior) date using system 100. In one variant, payment frequency and amount ratios are factored within this calculation. In another variant, the specified period may be a variable date range that includes start and end dates chosen by system 100 to locate uncharacteristic transactions (including patterns of large number of smaller transactions within a relatively short time period) in accordance with pre-bankruptcy associative elements 116.

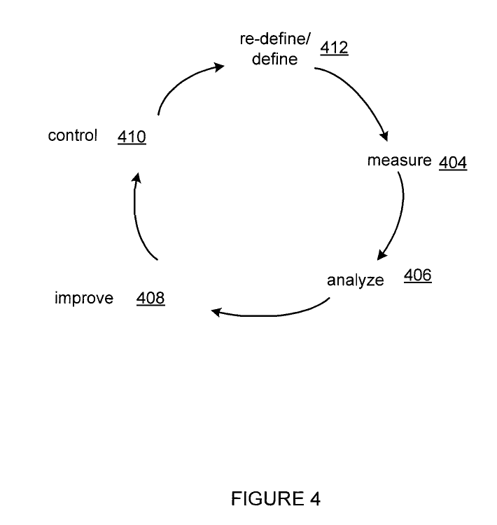

Referring to FIG. 4, relevant outputs and potential inputs suspected to impact each other are connected. System 100 generates one or more lists of potential measurements (e.g., pre-bankruptcy associative elements 116, pre-bankruptcy association rule algorithm 102, and pre-bankruptcy association learning rule algorithm) are utilized to analyze one or more sets of association data 112, 114 (data sets) to establish financial baseline 144. During processing of financial baseline 144, measurement errors are identified (e.g., algorithms discussed above determine related item sets or need to create additional item sets or associations). During start of input measurements, system 100 collects and processes outputs and data (e.g., consumer transactions are evaluated). During a validation phase, there is an indication that a problem exists (e.g., unusual, unique, repeat and/or consecutive transactions are analyzed). Based on measurements, e.g., measure 404, specifics of a problem may be used to redefine/define 412 and/or change an objective, e.g., analysis 406.

As such, system 100 electronically filters and traps data that contain erroneous or subjective conclusions. For instance, system 100 may do any or all the following: eliminate distracting data, choose another starting point 110 (e.g., unique point for each first and second set of association data 112, 114) to maximize recovery amount or improve, e.g., improve 408, scorecard value, recalculate debt by removing one of multiple credit cards from calculation to meet minimal dollar collection value requirements. In another instance, system 100 may reconcile non-misleading data patterns (control 410 by removing or avoiding payment history, which prevents credit card balance recovery) and storing key points thereof.

Referring again to FIG. 5, time stored transaction data (first set of financial transaction data and second set of financial transaction data) and each of their associative data sets illustrates credit card debtor initiates a spike in credit payments along with a cluster of purchases on clothing and jewelry. System 100 analyzes these spikes in credit usage and payments and creates a scorecard including objective evidence to use during collection processing.

In this example, five “5” consumers (operators SMITH, HILL, JONES, HANKS, MILLER) transactions were analyzed to determine a likelihood to declare bankruptcy. In this graph, a larger positive number from average (0) indicates an increase in daily credit balance than usual outstanding balance for a consumer for a given item set transaction. In other words, payments for the given item set have decreased during a specified period (t1 . . . tn). Continuing with this example, a large negative number from average (0) indicates a decrease in daily credit balance than usual outstanding balance for a consumer for a given item set transaction. For each consumer, plots of transactions for eight item sets are identified indicative of bankruptcy for a specified period.

For the customer SMITH, there are seven “7” out of “8” item sets having a positive deviation from average during the specified period. In this case, the average daily credit balance of all item sets is positive and between “3” and “6”; thus, SMITH has significantly increased a credit balance in identified bankruptcy specific item sets and is a good candidate for collection of outstanding credit card balance.

In contrast for customer Hill, there are eight “8” out of eight “8” item sets having a negative deviation (between −2 to −8) from average during a specified period. In this case, the average daily balance has significantly decreased a credit balance in identified bankruptcy specific item sets; thus, HILL is a poor candidate for outstanding credit card balance recovery. For customer JONES, there are five “5” out of eight “8” item set transactions above average (0), so JONES is an average candidate for collection of outstanding credit card balance. For customer HANKS, there are five “5” out of eight “8” item set transactions below average (0), so HANKS is a below average candidate for collection of outstanding credit card balance. For customer MILLER, there are seven “7” out of eight “8” item set transactions below average (0), so MILLER is a poor candidate (e.g., expeditiously pays off debt) for collection of outstanding credit card balance. As such, real-life transactions are evaluated for bankruptcy identifiable transactions in accordance with repeatability and reproducibility summary plots created by system 100.

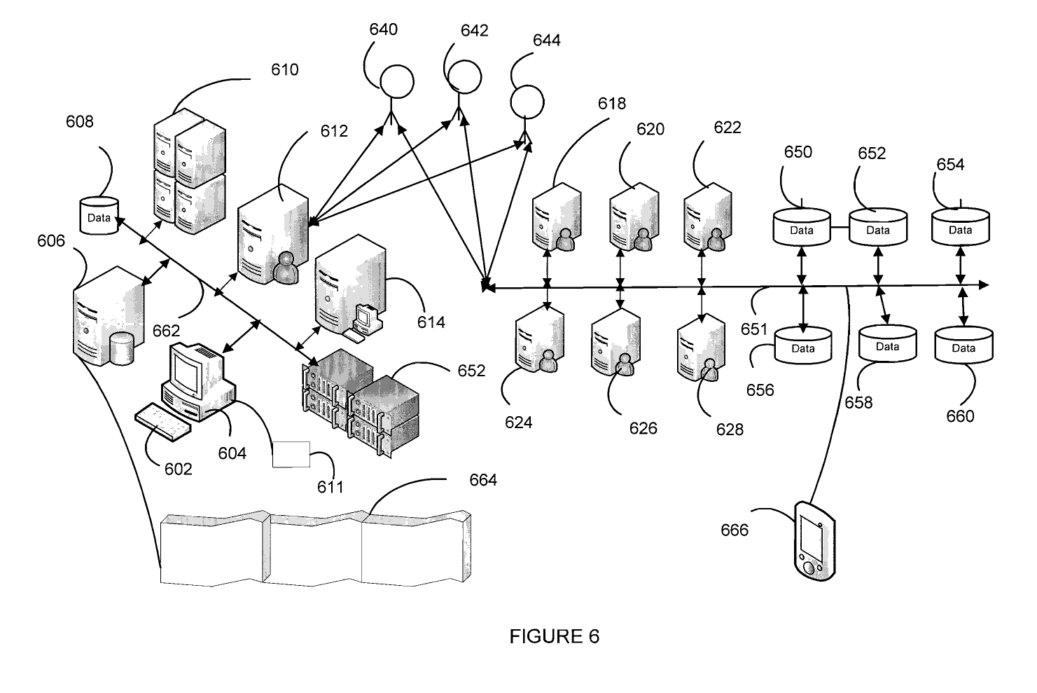

Referring to FIG. 6, system 600 communicates, for instance, using communications server 612 by wired or wireless means with banks, lenders, public databases extracting data utilizing consumer pre-bankruptcy detection algorithm of FIG. 1. System 600 includes data storage hardware devices 608, 610 capable of storage of first and second set of consumer transaction data 106, 104, first and second sets of association data 112, 114, as well as other components including pre-bankruptcy associative elements 116 on a temporary or permanent basis. Application server 606 stores program code, for example, pre-bankruptcy association rule algorithm 102, pre-bankruptcy association elements 116 is stored in a semi-transitory or non-transitory software media is capable of transferability using communications server 612 to transmit wired or wirelessly from processor unit 611, for example, communicatively coupled to computer 604 that has a keyboard 602 to allow a user to provide input thereto.

Continuing with this embodiment, system 100 may store program code in application server 606 in one or more tangible forms, for example, communicatively coupled to memory 664 (which may be ram, flash, or flash drive) or persistent storage 608, such as a hard drive or rewritable hard-disk external (that may be fixed or removable) that is communicatively coupled to computer 604, for instance, through bus line, e.g., bus line 662.

In one embodiment, communications server 612 transmits wirelessly to another network, e.g., radio towers, cell phone towers, communication satellites, or the like 640, 642, 644, to access private documents 140 (see FIG. 1) stored in one or more databases 650, 652, and 654 (e.g., private databases). In one variant, the one or more databases 650, 652, and 654 are one or more lending institutions accessible through communications servers 618, 620, and 622 coupled wirelessly, e.g., using communication satellites 640, 642, 644, or wired, for instance, to bus line, e.g., bus line 651. In another variant, communications server 612 transmits wirelessly to another network, e.g., radio towers, cell phone towers, communication satellites, or the like 640, 642, 644, to access public documents 126 (see FIG. 2) stored in one or more databases 656, 658, and 660 (e.g., court databases) that are, for instance, accessible through bus line, e.g., bus line 651. In yet another example, system 100 may be stored in memory in a consumer apparatus or product 666 (e.g., a hand-held computer with plug in serial, parallel, or usb adaptor compatibility) may be direct connected to bus line 651 or wirelessly access through communication satellites 640, 642, 644, e.g., one or more databases 650, 652, 654, 656, 658, 660 and/or accessing first or second set of consumer transaction data 106, 104.

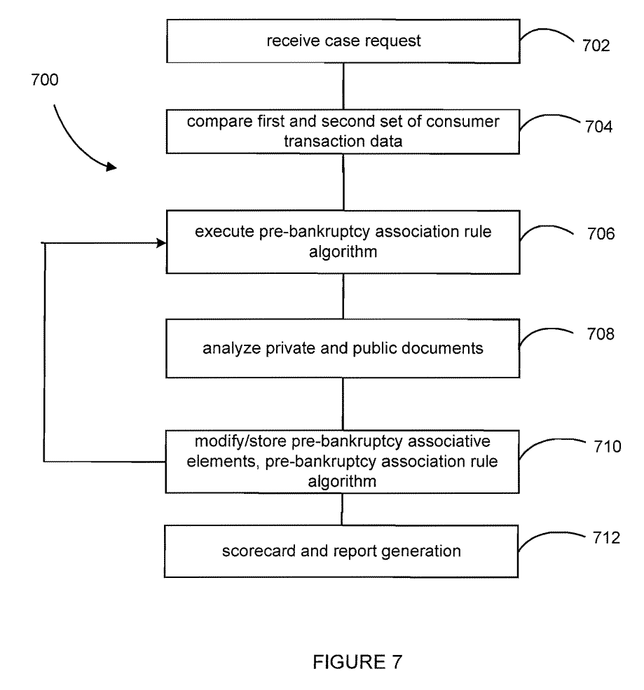

Referring to FIG. 7, flowchart 700 discloses a method for pre-detecting bankruptcy of a consumer with an outstanding credit card balance. In step 702, a case request is received. In step 704, first set of consumer transaction data 106 is compared to second set of consumer transaction data 104 in accordance with a debt grading criteria 128 to generate a first and second set of association data 112, 114. In one variant, starting point 110 is determined (on an individual outstanding creditor basis) for selection of first and second set of consumer transaction data 106, 104 to generate the first and second set of association data 112, 114 in accordance with one or more detections of a pattern of uncharacteristic credit card charges. In one variant of step 702, debt grading criteria 128 comprises adjusting confidence level 142 and financial baseline 14 for scorecard 148 (debt scorecard) based on real-time information obtained from recent transactions indicators including at least one of frequency of payment 118, level of payment 120, uncharacteristic purchase 121, types of charges 122, and frequency of charges 123. In yet another variant, first set of consumer transaction data 106 is older in time (e.g., earlier starting point 110) than second set of consumer transaction data 104.

In step 704, association rule algorithm (pre-bankruptcy association rule algorithm 102) is executed that parses association data into one or more product or service associations. In one variant of step 704, executing association rule algorithm 102 parses the association data (e.g., first and second set of association data 112, 114) in accordance with one or more product or service associations comprises executing pre-bankruptcy associate elements 116 against one or more complete or partially complete item sets or item combinations that are at least partially identified by the one or more product or service associations. In one variant, one or more complete or partially complete item sets includes one or more complete or partially complete product or service identification codes or text that when associated with each other assists identification of one or more uncharacteristic purchases (e.g., uncharacteristic purchase 121) including consumer spending pattern.

In step 706, transaction pattern is generated of the consumer based in part on relatedness of one or more product or service associations in conjunction with pre-bankruptcy associative elements 116. In one variant, execution of association rule algorithm (e.g., pre-bankruptcy association rule algorithm 102) parses the association data into one or more product or service associations comprises executing the pre-bankruptcy associate elements 116 against one or more complete or partially complete item sets or item combinations that are at least partially identified by one or more product or service associations.

In step 708, private documents 140 are analyzed from lien holders and public documents from pending and completed court cases to generate bankruptcy case success indicators. In yet another variant, further includes analyzing public documents 126 from pending and completed court cases comprises analyzing transactions of other debtors from pending and completed court cases 132 and adjusting association rule algorithm (e.g., pre-bankruptcy association rule algorithm 102) and pre-bankruptcy associative elements 116; and re-running association rule algorithm (e.g., pre-bankruptcy association rule association 102) against outstanding credit card transactions.

In step 710, pre-bankruptcy associative elements 116 are updated based on the generated bankruptcy case success indicators. In step 712, debt scorecard is generated (e.g., scorecard/report generation 148) that indicates a level of collectability of the outstanding credit card balance. In one variant, the consumer spending pattern comprises analysis of pre-bankruptcy associative elements 116 including analysis of the following factors: uncharacteristic purchase 121, location of charging, type of charges 112, time of charging, frequency and number of different charges (e.g., frequency of charges 123).

Advantageously, system 100 analyzes consumer transaction behavior to produce a neural network modeling algorithm (e.g., creates one or more sets of association rule algorithms) that detects objective elements of likely non-payment or fraud, e.g., intent to deceive. This consumer transaction behavior may be illustrated, for instance, based on deep data mining, e.g., elemental analysis, of key consumer data sets (e.g., one or more item sets). In one embodiment, neural network modeling algorithm classifies key consumer data sets into pre-bankruptcy associative elements including elemental categories. In one variant, elemental categories include types and kinds of charging items before an account holder declares bankruptcy. In yet another variant, consumer type of spending may be analyzed based on results of one or more uncharacteristic purchases of luxury items, e.g., boats, recreational vehicles, motorcycles, penthouses.

In yet another variant, other variables are utilized with the consumer type of spending patterns that are included in the pre-bankruptcy associative elements (e.g., fraud association elements) such as location of charging, timing of charging during day, frequency and number of different states of charging that occur in a specified time, e.g., 24 or 48 hours; and the like. As such, information relative to pre and post bankruptcy are run through a series of categorical quantitative and quantitative data tagging and processed using the above described association rule algorithms. Thus, this system sorts and groups debtor transactions and stores their respective dependencies.

Advantageously, the embodiments of the present invention may be utilized as credit card collection assistance or assistive tool for the collection of delinquent credit card balances by creditors. In other instance, principles of the present invention may, in many cases, provide a total recovery tool for generating objective evidence to assist in the collection of pending, overdue, and/or delinquent consumer credit card balances.

While the above detailed description has shown, described, and pointed out as novel features of the invention as applied to various embodiments, it will be understood that various omissions, substitutions, and changes in the form and details of the device or process illustrated may be made by those skilled in the art without departing from the invention. The foregoing description includes a best mode presently contemplated of carrying out the invention. This description is in no way meant to be limiting, but rather should be taken as illustrative of the general principles of the invention.

What is claimed is:

1. A method for pre-detecting bankruptcy of a consumer with an outstanding credit card balance comprising:
comparing a first set of consumer transaction data to a second set of consumer transaction data in accordance with a debt grading criteria to generate a first and second set of association data;
executing association rule algorithm that parses the first and second set of association data into one or more product or service associations;
generating a transaction pattern of the consumer based in part on relatedness of the one or more product or service associations in conjunction with pre-bankruptcy associative elements;
analyzing private documents from lien holders and public documents from pending and completed court cases to generate bankruptcy case success indicators;
updating the pre-bankruptcy associative elements based on one or more of the generated bankruptcy case success indicators; and
generating a debt scorecard that indicates a level of collectability of the outstanding credit card balance.

2. The method of claim 1 further comprising determining a starting point for selection of the first and second set of association data to generate in accordance with one or more detections a pattern of uncharacteristic credit card charges.

3. The method of claim 1 wherein the debt grading criteria comprises adjusting a confidence level and a financial baseline for the debt scorecard based on real-time information obtained from recent transactions indicators including at least one of frequency of payment, level of payment, types of charges, and frequency of charges.

4. The method of claim 1, wherein the first set of consumer transaction data includes older in time than the second set of consumer transaction data.

5. The method of claim 1, wherein analyzing public documents from pending and completed court cases comprises analyzing transactions of other debtors from pending and completed court cases and adjusting association rule algorithm and pre-bankruptcy associative elements; and rerunning association rule algorithm against outstanding credit card transactions.

6. The method of claim 1, wherein executing association rule algorithm that parses the first and second set of association data into one or more product or service associations comprises executing the pre-bankruptcy associative elements against one or more complete or partially complete item sets or item combinations that are at least partially identified by the one or more product or service associations.

7. The method of claim 6, wherein one or more complete or partially complete item sets comprises one or more complete or partially complete product or service identification codes or text that when associated with each other assists identification of one or more uncharacteristic purchases including a consumer spending pattern.

8. The method of claim 7, wherein the consumer spending pattern comprises analysis of the pre-bankruptcy associative elements includes analysis of the following factors: uncharacteristic purchase, location of charging, type of charging, time of charging, frequency of payment, and number of different charges.

9. A method for detecting credit card payment default, the method comprising:
comparing a first set of consumer transaction data to a second set of consumer transaction data in accordance with a debt grading criteria to generate association data;
selecting a starting point for selection of the first and second set of consumer transaction data to generate the association data in accordance with one or more detections of a pattern of uncharacteristic credit card charges; wherein the starting point provides a movable window to determine a listing of uncharacteristic purchases as compared to characteristic purchases;
executing association rule algorithm configured to utilize pre-bankruptcy associative elements against one or more complete or partially complete item sets or items combinations that are at least partially identified by one or more product associations and to parse the association data into the one or more product or service associations;
generating a transaction pattern of the consumer based in part on relatedness of the one or more product or service associations in conjunction with the pre-bankruptcy associative elements; and
executing the pre-bankruptcy associative elements against one or more complete or partially complete item sets or item combinations that are at least partially identified by the one or more product or service associations.

10. The method of claim 9 further comprising the step of analyzing private documents from lien holders and public documents from pending and completed court cases to generate bankruptcy case success indicators.

11. The method of claim 10 further comprising the step of updating pre-bankruptcy associative elements based on one or more generated bankruptcy case success indicators.

12. The method of claim 11 further comprising the step of generating a debt scorecard that indicates a level of collectability of the outstanding credit card balance.

13. The method of claim 9, wherein the first set of consumer transaction data is older in time than the second set of consumer transaction data.

14. The method of claim 9, wherein the debt grading criteria comprises adjusting a confidence level and a financial baseline for a debt scorecard based on real-time information obtained from recent transactions indicators including at least one of uncharacteristic purchase, frequency of payment, level of payment, and types of credit card charging.

15. The method of claim 10, wherein analyzing public documents from pending and completed court cases comprises analyzing transactions of other debtors from pending and completed court cases and adjusting association rule algorithm and pre-bankruptcy associative elements; and rerunning association rule algorithm against outstanding credit card transactions.

16. The method of claim 9, wherein one or more complete or partially complete item sets comprises one or more complete or partially complete product or service identification codes or text that when associated with each other assists identification of one or more uncharacteristic purchases including a consumer spending pattern.

17. The method of claim 16, wherein the consumer spending pattern comprises analysis of the pre-bankruptcy associative elements includes analysis of the following factors: uncharacteristic purchase, location of charging, type of charging, time of charging, frequency of and number of charges.

18. A method to assist in generation of objective evidence to recover consumer credit card transactions, the method comprising:
comparing a first set of consumer transaction data to a second set of consumer transaction data in accordance with a debt grading criteria to generate a first and second set of association data within a movable window determined by a selected starting point for selection of the first and second set of consumer transaction data in accordance with one or more detection pattern of uncharacteristic credit card charging;
executing association rule algorithm that parses the first and second set of association data into one or more product or service associations; and
generating a transaction pattern of the consumer based in part on relatedness of the one or more product or service associations in conjunction with pre-bankruptcy associative elements.

19. The method of claim 18, further comprising the steps of:
analyzing private documents from lien holders and public documents from pending and completed court cases to generate bankruptcy case success indicators.

20. The method of claim 19, further comprising the steps of:
updating pre-bankruptcy associative elements based on the generated bankruptcy case success indicators; and
generating a debt scorecard that indicates a level of collectability of the outstanding credit card balance.
